(19) United States
(12) Patent Application Publication
(10) Pub. No.: US 2013/0263671 A1
(43) Pub. Date: Oct. 10, 2013

(54) FLUID PRESSURE SPIKE ATTENUATION FEATURE FOR PRESSURE SENSING DEVICES

(71) Applicant: Chris Daniel Wagner, San Jose, CA (US)

(72) Inventor: Chris Daniel Wagner, San Jose, CA (US)

(73) Assignee: General Electric Company, Schenectady, NY (US)

(21) Appl. No.: 13/443,029

(22) Filed: Apr. 10, 2012

(51) Int. Cl. G01L 9/06; G01L 7/00

(52) U.S. Cl. 73/707

(57) ABSTRACT

A fluid pressure spike attenuation device and a method of attenuating a fluid pressure spike are provided. A fluid channel extends through an inlet body from a first open end to a second open end. The inlet body can be connected to a fluid pressure source and receive a fluid from the fluid pressure source. The fluid channel has an increased cross-sectional area to attenuate a fluid pressure spike entering the fluid channel at the first open end. A sensing element is in fluid communication with the second open end. The sensing element senses a property of the fluid in the fluid channel. The method includes providing an inlet body defining a fluid channel. The method also includes attenuating a fluid pressure spike by dissipating a pressure wave as it moves through the increased cross-sectional area of the fluid channel.

### BACKGROUND OF THE INVENTION

1. Field of the Invention

The invention relates to sensing devices, and specifically relates to fluid pressure spike attenuation for sensing devices.

2. Discussion of Prior Art

Pressure sensors are used to monitor fluid pressure in numerous applications. Such applications include, but are not limited to monitoring the pressure of transmission fluid within an automotive transmission. Pressure sensors often include a feature which allows the sensor to interface with the user's application allowing a fluid pressure to be measured for monitoring and/or control purposes. This feature can include a pathway permitting fluid communication between a pressure source and a sensor package. At times, relatively short fluid pressure spikes can enter the sensor package and damage sensitive components of the pressure sensor. After the damage, the pressure sensors can lose accuracy, exhibit a shift in data output, or simply fail to work.

Some previous methods of attenuating the fluid pressure spike include reduction of the fluid inlet cross-sectional area and the addition of a filter in the fluid inlet. These methods can include a higher cost of manufacturing, increase the chance of clogging, or require an actual fluid flow to be effective. Therefore, there is a need for an improved apparatus and method of attenuating fluid pressure spikes for pressure sensing devices.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a fluid pressure spike attenuation device. The fluid pressure spike attenuation device includes an inlet body which defines a fluid channel extending through the inlet body from a first open end to a second open end. The inlet body is configured to be connected to a fluid pressure source and receive a fluid from the fluid pressure source. The fluid pressure spike attenuation device also includes a sensing element in fluid communication with the second open end. The sensing element senses a property of the fluid in the fluid channel. The fluid channel has an increased cross-sectional area between the first open end and the second open end configured to attenuate a fluid pressure spike entering the fluid channel at the first open end.

In accordance with another aspect, the present invention provides a fluid fitting for sensing a property of a fluid. The fluid fitting includes an inlet body which defines a fluid channel extending through the inlet body from a first open end to a second open end. The inlet body is configured to be connected to a fluid pressure source and receive a fluid from the fluid pressure source. The fluid fitting further includes a sensing element housing configured to mate to the inlet body. The fluid fitting also includes a sensing element in fluid communication with the second open end. The sensing element senses a property of the fluid in the fluid channel. The fluid channel has an increased cross-sectional area between the first open end and the second open end configured to attenuate a fluid pressure spike entering the fluid channel at the first open end.

In accordance with another aspect, the present invention provides a method of attenuating a fluid pressure spike in a sensing device. The method includes providing an inlet body which defines a fluid channel extending through the inlet body from a first open end to a second open end. The inlet body is configured to be connected to a fluid pressure source and receive a fluid from the fluid pressure source. The fluid channel has an increased cross-sectional area between the first open end and the second open end. The method further includes providing a sensing element in fluid communication with the second open end. The sensing element senses properties of the fluid in the fluid channel. The method also includes attenuating a fluid pressure spike entering the fluid channel at the first open end by dissipating a pressure wave as the pressure wave moves through the increased cross-sectional area of the fluid channel. The fluid pressure spike is attenuated before it reaches the second open end.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized cross-sectional view of an example fluid pressure spike attenuation device including an example pressure sensor in accordance with an aspect of the present invention;

FIG. 2 is an enlarged cross-sectional view of a portion of the example fluid pressure spike attenuation device of FIG. 1; and

FIG. 3 is a top level flow diagram of an example method of attenuating a fluid pressure spike in a sensing device in accordance with an aspect of the present invention.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

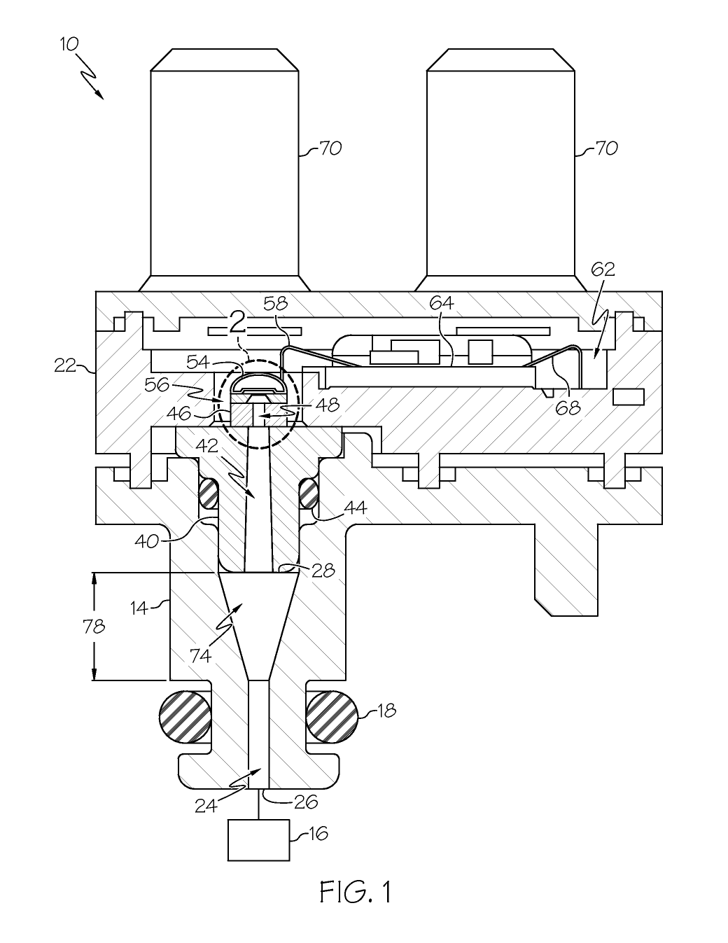

An example fluid pressure spike attenuation device is generally designated 10 within FIG. 1. It is to be appreciated that FIG. 1 merely shows one example and that other examples are contemplated within the present invention. The fluid pressure spike attenuation device 10 includes an inlet body 14. The inlet body 14 is configured to be in fluid communication with a fluid pressure source 16 (shown schematically in FIG. 1). In one example, the fluid pressure source could be the closed system of an automotive transmission, although other pressure sources are also contemplated. In one example, the fluid pressure spike attenuation device 10 is located on the outside of the fluid pressure source 16, such as an automotive transmission. The exterior of the inlet body 14 can be configured to be removably connected to the fluid pressure source 16 using any attachment methods as are known in the art. For example, the inlet body 14 may include structure such as a flare fitting, a quick disconnect, or a straight thread boss with an o-ring 18. The connection between the inlet body 14 and the fluid pressure source 16 can be pressure-tight so that the pressure of the fluid pressure source 16 can be transferred to the inlet body 14 without pressure loss to the exterior. In one example, the inlet body 14 can be configured to mate with a mating portion of an automotive transmission. In another example, the inlet body 14 can be a package feature which allows a sensor to interface with a user's application allowing fluid pressure to be measured. Another portion of the inlet body 14 can be configured to mate with a sensing element housing 22.

The inlet body 14 defines a first portion of a fluid channel 24 extending through the inlet body 14 from a first open end 26 to a second open end 28. The fluid channel 24 receives a fluid from the fluid pressure source 16 into the first open end 26. Fluid from the fluid pressure source 16 can then flow through the fluid channel 24 to reach the second open end 28.

Fluid from the fluid pressure source 16 can then transfer to a first carrier 40. The first carrier 40 can define a second portion of the fluid channel 24 as a central bore 42. The central bore 42 can have various cross-sectional profiles. As shown in FIG. 1, the cross-sectional profile of the central bore 42 can be tapered, although this is not intended to be limiting. For example, the cross-sectional profile of the central bore 42 can include parallel sides such as those of a straight bore or any other cross-sectional profile. Fluid from the fluid pressure source 16 can flow from one end of the first carrier 40 to the opposite end of the first carrier 40 through the central bore 42. In one example, the fluid channel 24 permits fluid communication between a fluid pressure source 16 and a sensing element 46.

The first carrier 40 can be configured to mate with mating structure of the inlet body 14. The connection between the first carrier 40 and the inlet body 14 can be pressure-tight so that the pressure of the fluid pressure source 16 can be transferred to the central bore 42 portion of the fluid channel 24 without pressure loss to the exterior. The pressure-tight connection between the first carrier 40 and the inlet body 14 can include an o-ring 44. The first carrier 40 can be constructed of any number of suitable materials including, but not limited to, a ceramic material.

After passing through the fluid channel 24, fluid from the fluid pressure source 16 is in fluid communication with a sensing element 46. The sensing element 46 can be configured for sensing a property of the fluid in the fluid channel 24. In one example, the sensing element 46 can sense the pressure of the fluid in the fluid channel 24. The sensing element 46 can include a blind hole 48. The surface of the sensing element 46 which is in communication with the fluid channel 24 is wetted by the fluid from the fluid pressure source 16.

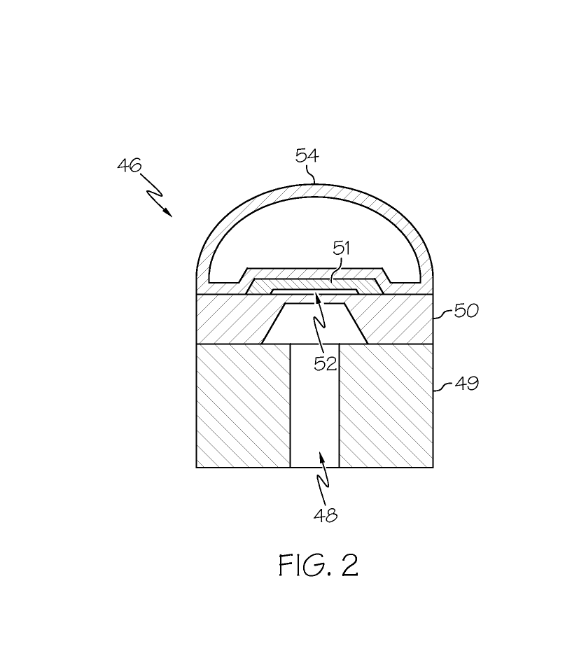

Turning to FIG. 2, an enlarged view of the sensing element 46 and associated components is shown. The sensing element 46 can include three individual components. The sensing element 46 can include a second carrier 49. The second carrier can have a cylindrical shape and define at least a portion of the blind hole 48. The sensing element 46 can also include a diaphragm 50 located on one end of the sensing element 46. As the fluid from the fluid pressure source 16 (best seen in FIG. 1) passes through the blind hole 48 of the second carrier 49, it contacts the diaphragm 50. The diaphragm 50 can be constructed of any number of suitable materials including, but not limited to, a silicone material. The diaphragm 50 creates a seal with the second carrier 49 in order to contain the fluid and the fluid pressure from the fluid pressure source 16 within the blind hole 48. The diaphragm 50 can further include deposited metallic traces (not shown) on the surface facing away from the second carrier 49.

The sensing element 46 can further include a cap 51 that is attached to the diaphragm 50. The cap 51 can be constructed of any number of suitable materials including, but not limited to, a ceramic composition. The geometry of the cap 51 can define a relatively small vacuum chamber 52 between the cap 51 and the diaphragm 50. The vacuum chamber 52 can be about 10 μm in distance from the diaphragm 50 to the cap 51. The pressure within the vacuum chamber 52 can be substantially 0 Pa so that a pressure sensing device can read absolute pressure of the fluid from the fluid pressure source 16. The pressure within the vacuum chamber 52 can be referred to as a reference vacuum on the sensing element 46.

In a pressure sensing device, the side of the sensing element 46 facing away from the blind hole 48 can be sealed to a dome-shaped structure 54 with the open side of the dome-shaped structure 54 facing the sensing element 46. As shown in FIG. 2, the dome-shaped structure can conform to the exposed areas of the diaphragm 50 and the cap 51. The dome-shaped structure 54 can be constructed of various materials including, but not limited to, a gel silicone material. The dome-shaped structure 54 protects the deposited metallic traces (not shown) on the surface of the diaphragm 50.

Returning to FIG. 1, the sensing element housing 22 can be a component that holds and aligns several other components in positions for proper working order and provide protective cover for other components. The sensing element 46 can hold the first carrier 40 in place and also define an aperture 56 for mounting the sensing element 46. Electrically conductive elements 58 such as wires or cable can be included in the sensing element housing 22 to transmit electrical signals from the sensing element 46 to a cavity 62 defined by the sensing element housing 22.

The cavity 62 can hold and provide protective cover for the processing device 64. The sensing element housing 22 can also include other electrically conductive elements 68 to transmit electronic signals from the processing device 64 to the exterior of the sensing element housing 22. The sensing element housing 22 can be constructed of several different materials. In one example, the sensing element housing 22 is constructed of plastic.

In one example, the sensing element 46 can be a piezo-resistive semiconductor die disposed in the cavity 62 of the sensing element housing 22. The piezo-resistive semiconductor die is responsive to pressure of the fluid in the fluid channel 24. Electrically conductive elements 58 such as wires or cable transmit electrical signals from the piezo-resistive semiconductor die to the processing device 64. The processing device 64 can be a programmable processor, electrical circuits, and other devices configured to collect and transmit information from the piezo-resistive semiconductor die. After processing, other electrically conductive elements 68 can transmit electrical signals from the processing device 64 to devices (not shown) outside the sensing element housing 22. For example, the other electrically conductive elements 68 can transmit electrical signals by electrical wire, plug, connector, or other device that is operatively configured to transmit data. In one particular example, the electrically conductive elements 68 can transmit electrical signals to terminals 70 configured to be the electrical interconnection from the fluid pressure spike attenuation device 10 to devices outside the sensing element housing 22.

In one example, the processing device 64 can convert an electrical signal from the sensing element 46 into an output voltage that is proportional to the applied pressure of the fluid from the fluid pressure source 16 acting on the sensing element 46. This output voltage can be transmitted by the other electrically conductive elements 68 to other processing equipment. Some applications may include a feedback loop that uses the output voltage in an algorithm to control various system parameters. In one example, the described fluid pressure spike attenuation device 10 can be included in one self-contained fluid fitting that can be removably attached to a fluid pressure source 16.

In the stated example of the sensing element 46 sensing a pressure in the fluid from the fluid pressure source 16 consisting of an automotive transmission, there can periodically be pressure spikes within the transmission fluid. During operation of the automobile, and particularly when the automobile is started, the amplitude of the pressure spike can reach about 1.38×10⁷ Pa (2,000 psi). At times, the amplitude of the pressure spike can reach about 2.07×10⁷ Pa (3,000 psi). Even short durations of these pressure spikes can damage the pressure sensing equipment. This can be particularly true for incompressible fluids such as the liquid of a transmission fluid in an automobile. While compressible fluids can absorb momentum transfer, incompressible liquids do not have this capability. For example, the ceramic material of the cap 51 (best seen in FIG. 2) can crack when subjected to a 1.38×10⁷ Pa (2,000 psi) pressure spike. After the cap 51 is cracked, the electrical signal output from the processing device 64 is often shifted and does not represent the actual pressure of the transmission fluid. As a result, the entire fluid fitting has to be replaced to obtain an accurate transmission fluid pressure reading.

The likelihood of damage to the sensing element 46 can be reduced by attenuating a fluid pressure spike prior to reaching the second open end 28 in the inlet body 14. In order to attenuate the fluid pressure spike, the fluid channel 24 has an increased cross-sectional area 74 between the first open end 26 and the second open end 28. As the fluid pressure spike wave travels from the first open end 26 toward the second open end 28, it encounters the increased cross-sectional area 74. The increased cross-sectional area 74 increases volume which decreases the energy density of the fluid pressure spike to attenuated the fluid pressure spike.

For the purposes of this disclosure, the energy density of the fluid pressure spike is described by the equation of ED=E/A; where ED represents energy density, E represents energy, and A represents the area over which the energy acts. This relationship demonstrates that an increased value of A (the area upon which the energy acts) results in a decreased value of ED. Thus, as the fluid pressure spike enters the increased cross-sectional area 74 and the pressure wave widens to the increased area, the energy density of the pressure wave is decreased and therefore has less energy to crack the cap 51 (best seen in FIG. 1) when the fluid pressure spike wave acts on the sensing element 46. A fluid pressure spike wave with less energy density is less likely to damage sensing element 46 components including the cap 51.

In one example, the increased cross-sectional area 74 can be a taper that varies over a length 78 of the fluid channel 24 to form a frustoconical cavity in the fluid channel 24. Other cross-sectional cavity shapes are also contemplated, for example, square, ovoid, and rectangular. Other cavity shapes can be effective so long as the cavity defines a greater surface area and an increased cross-sectional area when compared to the remainder of the fluid channel 24 through which the fluid of the fluid pressure source 16 must pass prior to the fluid pressure spike wave reaching the second open end 28. In order to more effectively attenuate the fluid pressure spike, the diameter and length 78 of the increased cross-sectional area 74 can be maximized within the structural limits of the inlet body 14. However, while adding the increased cross-sectional area 74 to the inlet body 14, it is also desirable to maintain the exterior dimensions of the inlet body 14, and the remainder of the pressure sensor components. In one example, the length 78 of the increased cross-sectional area 74 is 4 mm.

In one example, the fluid pressure spike can be attenuated from a pressure between about 1.38×10⁷ Pa (2,000 psi) and 2.07×10⁷ Pa (3,000 psi) to about 6.2×10⁶ Pa (900 psi) by passing the fluid pressure spike through the increased cross-sectional area 74. The increased cross-sectional area 74 is configured to attenuate transitory fluid pressure spikes of a relatively short duration. In one example, the fluid pressure spike can last for less than about 20 microseconds. During the transitory fluid pressure spike, the pressure sensed by the sensing element 46 is not affected, and control of the automotive transmission is not impacted. As the fluid pressure spike increases in duration, the system pressure will move from a dynamic pressure condition to a static pressure condition at which point the increased cross-sectional area 74 will become less effective to protect pressure sensing structure which is sensitive to relatively high fluid pressures.

There are several advantages associated with the inclusion of an increased cross-sectional area 74 in a fluid pressure spike attenuation device 10. The fluid pressure spike attenuation device 10 and the fluid fitting using the fluid pressure spike attenuation device 10 help increase the reliability of reading transmission fluid pressures by helping to eliminate pressure damage to pressure sensors. Therefore, the fluid pressure spike attenuation device 10 allows a sensor to be robust to environments with fluid pressure spikes. The increased cross-sectional area 74 can be a taper in the fluid channel 24 created by a relatively minor change to an injection mold tool. In one example, the increased cross-sectional area 74 can be used in an inlet body 14 with the same exterior dimensions. It can be beneficial to use a pressure sensor with the same footprint, as the spaces in which a transmission fluid pressure sensor are used can be limited. Thus, no design changes are required in order to locate the fluid pressure spike attenuation device 10 in traditional locations. Additionally, the fluid pressure spike attenuation device 10 includes the same wetted area on the sensing element 46 as on previous designs, therefore, no design changes are required for the sensing element 46 or the dome-shaped structure 54.

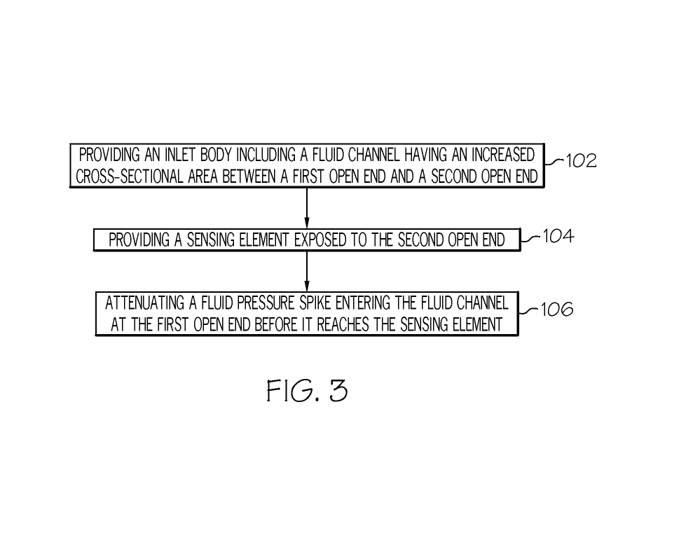

An example method of attenuating a fluid pressure spike in a sensing device is generally described in FIG. 3. The method can be performed in connection with the example fluid pressure spike attenuation device 10 shown in FIG. 1. The method includes the step 102 of providing an inlet body. The inlet body defines a fluid channel extending through the inlet body from a first open end to a second open end. The inlet body is configured to be removably connected to a fluid pressure source, and the fluid channel receives a fluid from the fluid pressure source. The fluid channel has an increased cross-sectional area between the first open end and the second open end.

The method also includes the step 104 of providing a sensing element in fluid communication with the second open end. The sensing element senses properties of the fluid in the fluid channel. The method further includes the step 106 of attenuating a fluid pressure spike entering the fluid channel at the first open end by dissipating a pressure wave as the pressure wave moves through the increased cross-sectional area of the fluid channel. The fluid pressure spike is attenuated before it reaches the second open end.

In another example of the method, the increased cross-sectional area varies over a length of the fluid channel to form a frustoconical cavity in the fluid channel. In another example of the method, the sensing device includes a piezo-resistive semiconductor die disposed in an aperture of the sensing element housing, and the piezo-resistive semiconductor die is responsive to pressure of the fluid in the fluid channel.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A fluid pressure spike attenuation device including:
an inlet body, wherein the inlet body defines a fluid channel extending through the inlet body from a first open end to a second open end, wherein the inlet body is configured to be connected to a fluid pressure source, the fluid channel receiving a fluid from the fluid pressure source; and
a sensing element in fluid communication with the second open end, the sensing element for sensing a property of the fluid in the fluid channel,
wherein the fluid channel has an increased cross-sectional area between the first open end and the second open end configured to attenuate a fluid pressure spike entering the fluid channel at the first open end.

2. The fluid pressure spike attenuation device according to claim 1, wherein the increased cross-sectional area is configured to attenuate fluid pressure spikes of a relatively short duration.

3. The fluid pressure spike attenuation device according to claim 2, wherein the relatively short duration is less than about 20 microseconds.

4. The fluid pressure spike attenuation device according to claim 1, wherein the amplitude of the pressure spike is less than about 1.38×10⁷ Pa (2,000 psi).

5. The fluid pressure spike attenuation device according to claim 1, wherein the amplitude of the pressure spike is less than about 2.07×10⁷ Pa (3,000 psi).

6. The fluid pressure spike attenuation device according to claim 1, wherein the increased cross-sectional area varies over a length of the fluid channel to form a frustoconical cavity in the fluid channel.

7. The fluid pressure spike attenuation device according to claim 1, wherein the property of the fluid sensed is a pressure.

8. The fluid pressure spike attenuation device according to claim 1, wherein the sensing device includes a piezo-resistive semiconductor die disposed on a surface of the sensing element housing, and wherein the piezo-resistive semiconductor die is responsive to pressure of the fluid in the fluid channel.

9. The fluid pressure spike attenuation device according to claim 1, further including a processing device coupled to the sensing element, wherein the processing device is configured to collect and transmit information from the sensing element.

10. A fluid fitting for sensing a property of a fluid including:
an inlet body, wherein the inlet body defines a fluid channel extending through the inlet body from a first open end to a second open end, wherein the inlet body is configured to be connected to a fluid pressure source, the fluid channel receiving a fluid from the fluid pressure source;
a sensing element housing configured to mate to the inlet body; and
a sensing element, wherein the sensing element is in fluid communication with the second open end, the sensing element for sensing a property of the fluid in the fluid channel
wherein the fluid channel has an increased cross-sectional area between the first open end and the second open end configured to attenuate a fluid pressure spike entering the fluid channel at the first open end.

11. The fluid fitting according to claim 10, wherein the increased cross-sectional area is configured to attenuate fluid pressure spikes of a relatively short duration.

12. The fluid fitting according to claim 11, wherein the relatively short duration is less than about 20 microseconds.

13. The fluid fitting according to claim 10, wherein the amplitude of the pressure spike is between about 1.38×10⁷ Pa (2,000 psi) and 2.07×10⁷ Pa (3,000 psi).

14. The fluid, fitting according to claim 10, wherein the increased cross-sectional area varies over a length of the fluid channel to form a frustoconical cavity in the fluid channel.

15. The fluid fitting according to claim 10, wherein the property of the fluid sensed is a pressure.

16. The fluid fitting according to claim 10, wherein the sensing device includes a piezo-resistive semiconductor die disposed on a surface of the sensing element housing, and wherein the piezo-resistive semiconductor die is responsive to pressure of the fluid in the fluid channel.

17. The fluid fitting according to claim 10, further including a processing device coupled to the sensing element, wherein the processing device is configured to collect and transmit information from the sensing element, the processing device disposed in a cavity of the sensing element housing.

18. A method of attenuating a fluid pressure spike in a sensing device including:
providing an inlet body, wherein the inlet body defines a fluid channel extending through the inlet body from a first open end to a second open end, wherein the inlet body is configured to be connected to a fluid pressure source, the fluid channel receiving a fluid from the fluid pressure source, wherein the fluid channel has an increased cross-sectional area between the first open end and the second open end;
providing a sensing element in fluid communication with the second open end, the sensing element for sensing properties of the fluid in the fluid channel; and
attenuating a fluid pressure spike entering the fluid channel at the first open end by dissipating a pressure wave as the pressure wave moves through the increased cross-sectional area of the fluid channel, wherein the fluid pressure spike is attenuated before it reaches the second open end.

19. The method according to claim 18, wherein the wherein the increased cross-sectional area varies over a length of the fluid channel to form a frustoconical cavity in the fluid channel.

20. The method according to claim 18, wherein the sensing device includes a piezo-resistive semiconductor die disposed in an aperture of the sensing element housing, and wherein the piezo-resistive semiconductor die is responsive to pressure of the fluid in the fluid channel.
